(19) United States
(12) Patent Application Publication
(10) Pub. No.: US 2013/0155286 A1
(43) Pub. Date: Jun. 20, 2013

(54) ELECTRONIC CAMERA

(71) Applicant: Sanyo Electric Co., Ltd., Moriguchi-shi (JP)

(72) Inventor: Akihiro Yumisaki, Moriguchi-shi (JP)

(73) Assignee: Sanyo Electric Co., Ltd., Moriguchi-shi (JP)

(21) Appl. No.: 13/720,397

(22) Filed: Dec. 19, 2012

(30) Foreign Application Priority Data
Dec. 19, 2011 (JP) 2011-277441

(51) Int. Cl. H04N 5/232

(52) U.S. Cl. CPC H04N 5/23293
USPC 348/231.99

(57) ABSTRACT

An electronic camera includes an imager. An imager repeatedly outputs an electronic image corresponding to an optical image captured on an imaging surface. A displayer displays the electronic image outputted from the imager, in parallel with a process of the imager. An adjuster adjusts an imaging condition based on the electronic image outputted from the imager when a specific key is transitioned to a first operation state. A recorder records the electronic image outputted from the imager under the imaging condition adjusted by the adjuster, in response to transition of the specific key to a second operation state. A stopper stops the imager and/or the displayer during a period of non-operation of the specific key when a battery voltage falls below a first reference value.

### CROSS REFERENCE OF RELATED APPLICATION

The disclosure of Japanese Patent Application No. 2011-277441, which was filed on Dec. 19, 2011, is incorporated herein by reference.

### BACKGROUND OF THE INVENTION

1. Field of the Invention

The present invention relates to an electronic camera, and in particular, relates to an electronic camera which displays an electronic image outputted from an imaging device in real time.

2. Description of the Related Art

According to one example of this type of camera, when a shooting operation is performed while a user recognizes a real-time image of a subject by sight, a frame rate of a live view display on an EVF or an LCD is set to a reference frame rate. In contrary, when the shooting operation is not performed while the user recognizes the real-time image of the subject by sight, the frame rate of the live view display on the EVF or the LCD is set to a frame rate lower than the reference frame rate. Moreover, the frame rate is decreased depending on a remaining amount of a battery. Thereby, a power consumption per unit time is reduced.

However, in the above-described camera, the live view display is continued while inhibiting the frame rate, and therefore, a capability of reducing the power consumption is limited. Here, when the live view display is suspended, an operability is deteriorated while the capability of reducing the power consumption is improved.

### SUMMARY OF THE INVENTION

An electronic camera according to the present invention comprises: an imager which repeatedly outputs an electronic image corresponding to an optical image captured on an imaging surface; a displayer which displays the electronic image outputted from the imager, in parallel with a process of the imager; an adjuster which adjusts an imaging condition based on the electronic image outputted from the imager when a specific key is transitioned to a first operation state; a recorder which records the electronic image outputted from the imager under the imaging condition adjusted by the adjuster, in response to transition of the specific key to a second operation state; and a stopper which stops the imager and/or the displayer during a period of non-operation of the specific key when a battery voltage falls below a first reference value.

According to the present invention, an imaging control program recorded on a non-transitory recording medium in order to control an electronic camera provided with an imager which repeatedly outputs an electronic image corresponding to an optical image captured on an imaging surface; and a displayer which displays the electronic image outputted from the imager, in parallel with a process of the imager, the program causing a processor of the electronic camera to perform the steps comprises: an adjusting step of adjusting an imaging condition based on the electronic image outputted from the imager when a specific key is transitioned to a first operation state; a recording step of recording the electronic image outputted from the imager under the imaging condition adjusted by the adjusting step, in response to transition of the specific key to a second operation state; and a stopping step of stopping the imager and/or the displayer during a period of non-operation of the specific key when a battery voltage falls below a first reference value.

According to the present invention, an imaging control method executed by an electronic camera provided with an imager which repeatedly outputs an electronic image corresponding to an optical image captured on an imaging surface; and a displayer which displays the electronic image outputted from the imager, in parallel with a process of the imager, comprises: an adjusting step of adjusting an imaging condition based on the electronic image outputted from the imager when a specific key is transitioned to a first operation state; a recording step of recording the electronic image outputted from the imager under the imaging condition adjusted by the adjusting step, in response to transition of the specific key to a second operation state; and a stopping step of stopping the imager and/or the displayer during a period of non-operation of the specific key when a battery voltage falls below a first reference value.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an assignment state of an evaluation area on an imaging surface;

FIG. 4(A) is a timing chart showing one portion of behavior in the embodiment shown in FIG. 2 when a battery voltage is equal to or more than a threshold value TH_high;

FIG. 4(B) is a timing chart showing one portion of behavior in the embodiment shown in FIG. 2 when the battery voltage is less than the threshold value TH_high and is equal to or more than a threshold value TH_low;

FIG. 4(C) is a timing chart showing one portion of behavior in the embodiment shown in FIG. 2 when the battery voltage is less than the threshold value TH_low;

FIG. 5 is a flowchart showing one portion of behavior of a CPU applied to the embodiment in FIG. 2;

FIG. 6 is a flowchart showing another portion of behavior of the CPU applied to the embodiment in FIG. 2;

FIG. 7 is a flowchart showing still another portion of behavior of the CPU applied to the embodiment in FIG. 2; and

FIG. 8 is a block diagram showing a configuration of another embodiment of the present invention.

### DETAILED DESCRIPTION OF THE PREFERRED EMBODIMENTS

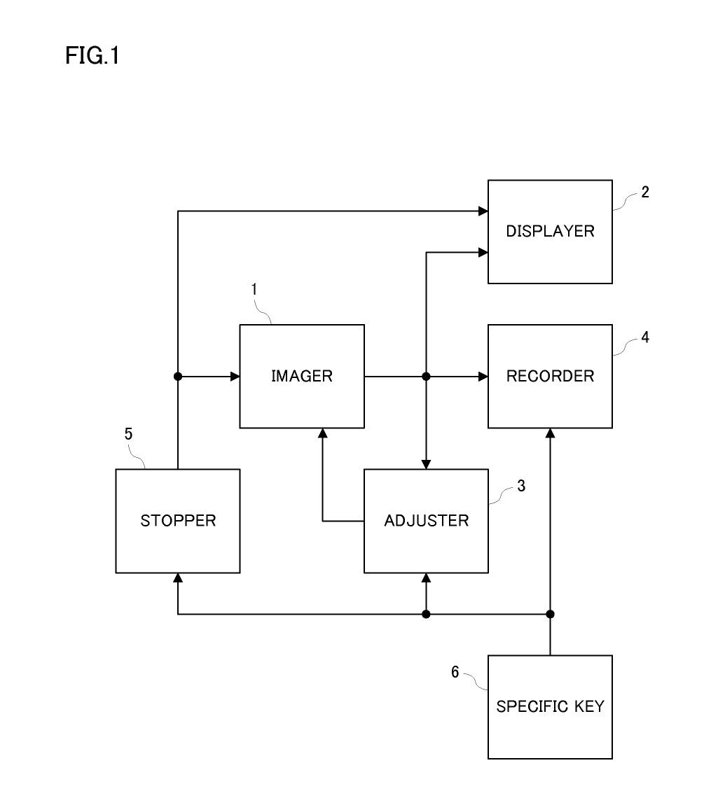

With reference to FIG. 1, an electronic camera according to one embodiment of the present invention is basically configured as follows: An imager 1 repeatedly outputs an electronic image corresponding to an optical image captured on an imaging surface. A displayer 2 displays the electronic image outputted from the imager 1, in parallel with a process of the imager 1. An adjuster 3 adjusts an imaging condition based on the electronic image outputted from the imager 1 when a specific key 6 is transitioned to a first operation state. A recorder 4 records the electronic image outputted from the imager 1 under the imaging condition adjusted by the adjuster 3, in response to transition of the specific key 6 to a second operation state. A stopper 5 stops the imager 1 and/or the displayer 2 during a period of non-operation of the specific key 6 when a battery voltage falls below a first reference value.

The electronic image outputted from the imager 1 is displayed by the displayer 2, adjusting the imaging condition is executed when the specific key 6 is transitioned to the first operation state, and recording the electronic image is executed when the specific key 6 is transitioned to the second operation state. Based on this, when the battery voltage is equal to or more than the first reference value, the imager 1 and the displayer 2 are activated irrespective of operation/non-operation of the specific key 6. In contrary, when the battery voltage is less than the first reference value, the imager 1 and/or the displayer 2 are stopped during the period of non-operation of the specific key 6. Thereby, power consumption is constrained, and an operability is improved.

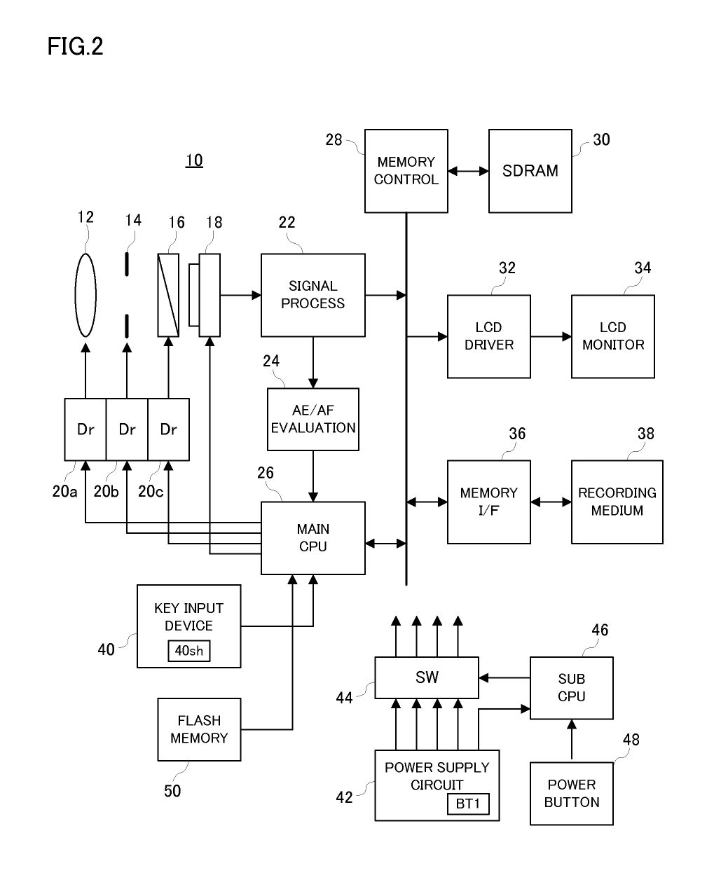

With reference to FIG. 2, a digital camera 10 according to one embodiment includes a focus lens 12, an aperture unit 14 and a shutter unit 16 driven by drivers 20a, 20b and 20c, respectively.

Moreover, the digital camera 10 includes a power supply circuit 42 containing a battery BT1. The power supply circuit 42 generates a plurality of direct current power supplies, each of which shows a different voltage value. One portion of the plurality of generated direct current power supplies is directly applied to a sub CPU 46, and another portion of the plurality of generated direct current power supplies is applied to a camera system (except the sub CPU 46) via a main power switch 44.

The sub CPU 46 turned on by the direct current power supplies from the power supply circuit 42 turns on the main power switch 44 in response to a power-on operation by a power button 48, and turns off the main power switch 44 in response to a power-off operation by the power button 48. Thus, the camera system is activated by turning on the power button 48, and is stopped by turning off the power button 48.

When the buttery voltage is equal to or more than a threshold value TH_high, a main CPU 26 opens the shutter unit 16 through the driver 20c, and sets a low-resolution mode to a CMOS-type image sensor 18. Moreover, the main CPU 26 activates the image sensor 18, a signal processing circuit 22 and an LCD driver 32 in order to start a moving-image taking process.

An optical image representing a scene is irradiated onto an imaging surface of the image sensor 18 through the focus lens 12, the aperture unit 14 and the shutter unit 16. The image sensor 18 exposures the imaging surface by a rolling shutter system, at every time a vertical synchronization signal Vsync is generated, and reads out a part of electric charges produced thereby from the imaging surface, in a raster scanning manner. As a result, low-resolution raw-image data that is based on the read-out electric charges is repeatedly outputted from the image sensor 18.

The pre-processing circuit 22 performs processes, such as color separation, white balance adjustment and YUV conversion, on the raw image data outputted from the image sensor 18, and writes YUV formatted image data produced thereby into an SDRAM 30 through a memory control circuit 28. The LCD driver 32 repeatedly reads out the image data stored in the SDRAM 30 through the memory control circuit 28, and drives an LCD monitor 34 based on the read-out image data. As a result, a real-time moving image (a live view image) representing the scene captured on the imaging surface is displayed on a monitor screen.

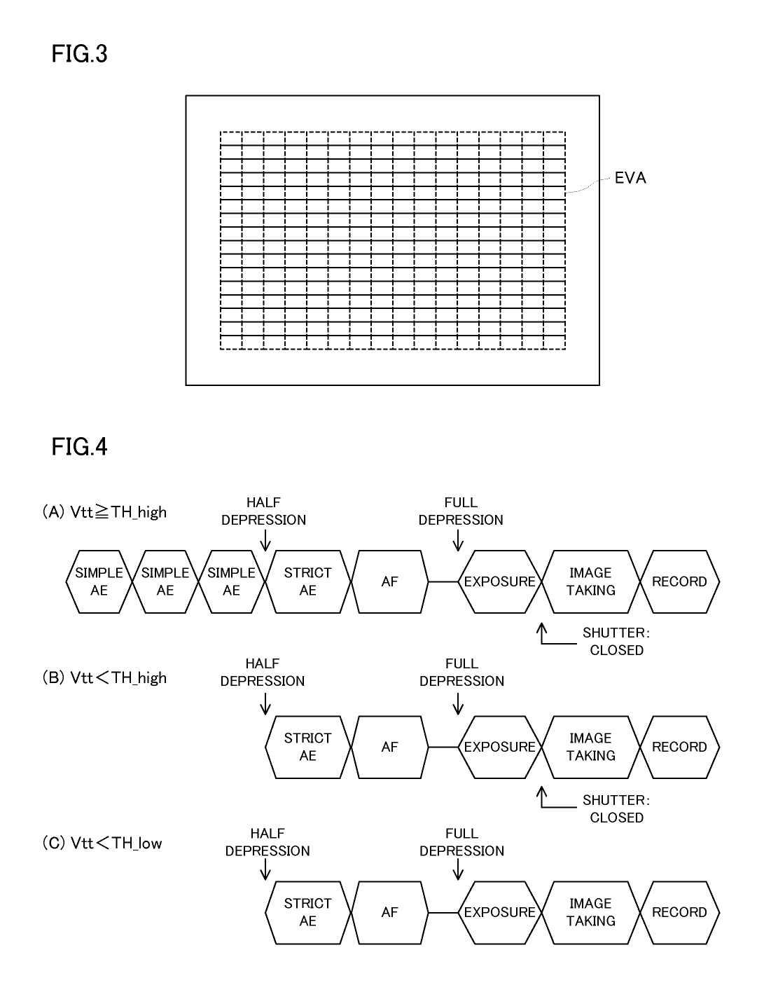

With reference to FIG. 3, an evaluation area EVA is assigned to the imaging surface. The evaluation area EVA is divided into 16 portions in each of a horizontal direction and a vertical direction; therefore, a total of 256 divided areas are arranged on the imaging surface in a matrix. The signal processing circuit 22 applies Y data which forms the YUV formatted image data to an AE/AF evaluating circuit 24.

The AE/AF evaluating circuit 24 integrates the applied Y data for each divided area so as to create a total of 256 integral values as luminance evaluation values. Moreover, the AE/AF evaluating circuit 24 integrates a high-frequency component of the applied Y data for each divided area so as to create a total of 256 integrated values as AF evaluation values. These integrating processes are repeatedly executed at every time the vertical synchronization signal Vsync is generated. As a result, 256 luminance evaluation values and 256 AF evaluation values are outputted from the AE/AF evaluating circuit 24 in response to the vertical synchronization signal Vsync.

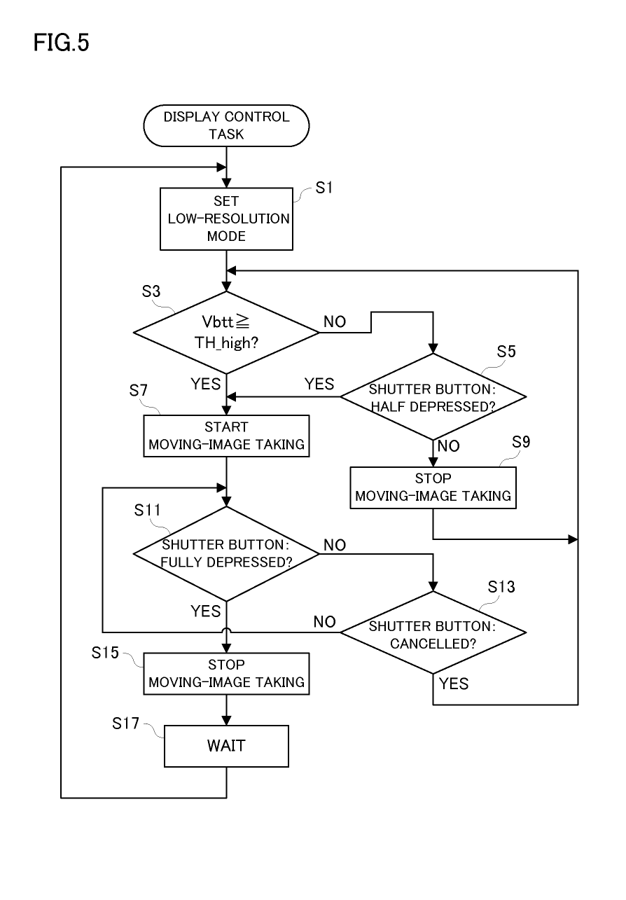

With reference to FIG. 4, when a shutter button 40sh arranged in a key input device 40 is in a non-operated state, the main CPU 26 executes a simple AE process with reference to the 256 luminance evaluation values outputted from the AE/AF evaluating circuit 24 so as to calculate an appropriate EV value. An aperture amount and an exposure time period that define the calculated appropriate EV value are set to the driver 20b and the image sensor 18, and thereby, a brightness of the live view image is adjusted approximately.

When the shutter button 40sh is half-depressed, the main CPU 26 executes a strict AE process referring to the luminance evaluation values so as to calculate an optimal EV value. Also an aperture amount and an exposure time period that define the calculated optimal EV value are set to the driver 20b and the image sensor 18, and thereby, a brightness of the live view image is adjusted strictly. Moreover, the main CPU 26 executes an AF process based on the 256 AF evaluation values outputted from the AE/AF evaluating circuit 24. The focus lens 12 is set to a focal point discovered by the AF process, and thereby, a sharpness of the live view image is improved.

When the shutter button 40sh is fully-depressed, the main CPU 26 sets a high-resolution mode to the image sensor 18, and closes the shutter unit 16 at a timing corresponding to the exposure time period adjusted by the strict AE process (see FIG. 4(A)).

Subsequently, the main CPU 26 commands the image sensor 18 to output one frame of raw image data. The image sensor 18 reads out, in a raster scanning manner, all of the electric charges produced on the imaging surface immediately before the shutter unit 16 is closed. As a result, high-resolution raw-image data equivalent to one frame is outputted from the image sensor 18, and YUV formatted image data based thereon is written into the SDRAM 30.

Thereafter, the main CPU 26 commands the memory I/F 36 to execute a recording process. The memory I/F 36 reads out the high-resolution image data stored in the SDRAM 30 through the memory control circuit 28, and records the read-out image data on a recording medium 38 in a file format. The shutter unit 16 is opened upon completion of the recording process, and the moving-image taking process described above is restarted.

When the buttery voltage falls below the threshold value TH_high, the main CPU 26 stops the moving-image taking process until the shutter button 40sh is half depressed. Since the simple AE process is a process performed in a period during which the operation of the shutter button 40sh is cancelled, if the battery voltage falls below the threshold value TH_high, the simple AE process is restricted or prohibited (see FIG. 4(B)).

As a result, the live view image is displayed on the LCD monitor 34 in response to the shutter button 40sh being half depressed. An operator is able to perform framing by using the LCD monitor 34 after the shutter button 40sh is half depressed.

Furthermore, when the battery voltage falls below a threshold value TH_low smaller than the threshold value TH_high, the main CPU 26 restricts or prohibits a closing behavior of the shutter unit 16 in response to the shutter button 40sh being fully depressed (see FIG. 4(C)). As a result, while an image may be distorted resulting from the exposure by the rolling shutter system, it becomes possible to constrain the power consumption for the closing behavior of the shutter unit 16.

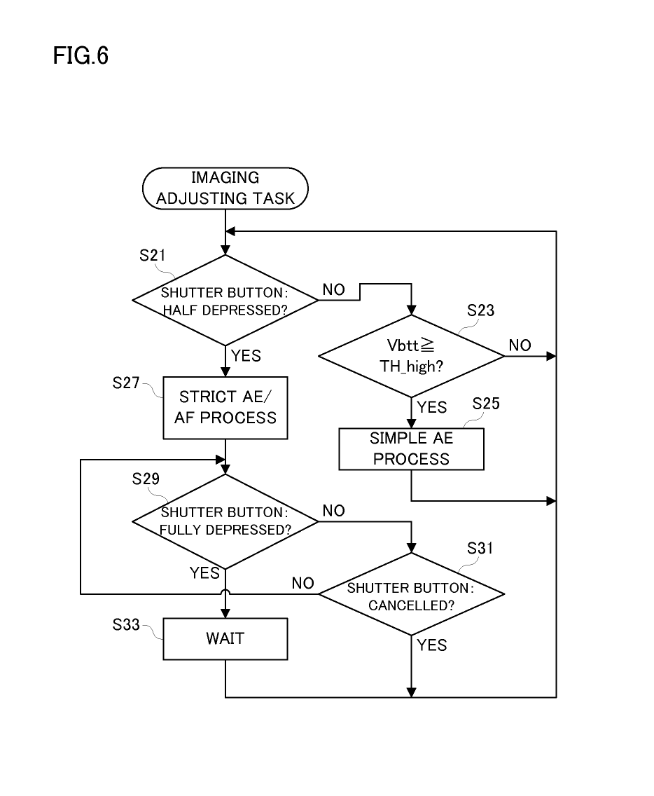

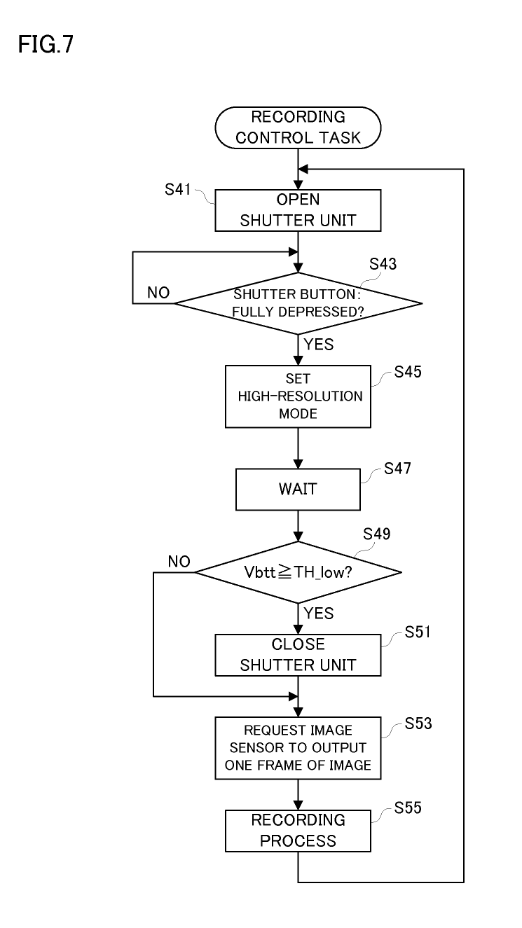

The main CPU 26 executes, under a control of the multi task operating system, a plurality of tasks including a display control task shown in FIG. 5, an imaging adjusting task shown in FIG. 6 and a recording control task shown in FIG. 7, in a parallel manner. It is noted that control programs corresponding to these tasks are stored in a flash memory 50.

With reference to FIG. 5, in a step S1, the low-resolution mode is set to the image sensor 18. In a step S3, it is determined whether or not the battery voltage Vtt is equal to or more than the threshold value TH_high, and in a step S5, it is determined whether or not the shutter button 40sh is half depressed.

When one of a determined result of the step S3 and a determined result of the step S5 is YES, the process advances to a step S7 so as to activate the image sensor 18, the signal processing circuit 22 and the LCD driver 32 in order to start the moving-image taking process. As a result, low-resolution raw-image data is repeatedly outputted from the image sensor 18, and a live view image based thereon is displayed on the LCD monitor 34.

In contrary, when both of the determined result of the step S3 and the determined result of the step S5 are NO, the process advances to a step S9 so as to stop the image sensor 18, the signal processing circuit 22 and the LCD driver 32 in order to end the moving-image taking process. As a result, the live view image is hidden.

Upon completion of the process in the step S7, the process advances to a step S11 whereas upon completion of the process in the step S9, the process returns to the step S3. It is noted that, the process in the step S7 in a state where the moving-image taking process is started is meaningless, and the process in the step S9 in a state where the moving-image taking process is stopped is also meaningless.

In a step S11, it is determined whether or not the shutter button 40sh is fully depressed, and in a step S13, it is determined whether or not the operation of the shutter button 40sh is cancelled. When a determined result of the step S13 is YES, the process returns to the step S3 whereas when a determined result of the step S11 is YES, the process advances to a step S15. In the step S15, a process similar to the step S9 described above is executed. In a step S17, the process waits until a process in a step S55 described later is completed, and returns to the step S1 thereafter.

With reference to FIG. 6, in a step S21, it is determined whether or not the shutter button 40sh is half depressed, and in a step S23, it is determined whether or not the battery voltage Vtt is equal to or more than the threshold value TH_high.

When both of a determined result of the step S21 and a determined result of the step S23 are NO, the process directly returns to the step S21. When the determined result of the step S21 is NO and when the determined result of the step S23 is YES, the simple AE process is executed in a step S25, and thereafter, the process returns to the step S21. A brightness of the live view image is roughly adjusted by the simple AE process.

When the determined result of the step S21 is YES, in a step S27, the strict AE process and the AF process are executed. The brightness of the live view image is strictly adjusted by the strict AE process, and a sharpness of the live view image is improved by the AF process.

In a step S29, it is determined whether or not the shutter button 40sh is fully depressed, and in a step S31, it is determined whether or not the operation of the shutter button 40sh is cancelled. When a determined result of the step S31 is YES, the process directly returns to the step S21. In contrary, when a determined result of the step S29 is YES, in a step S33, the process waits until the process in the step S55 described later is completed, and returns to the step S21 thereafter.

With reference to FIG. 7, in a step S41, the shutter unit 16 is opened through the driver 20c. As a result, an optical image via the focus lens 12 and the aperture unit 14 is irradiated onto the imaging surface. In a step S43, it is determined whether or not the shutter button 40sh is fully depressed. When a determined result is updated from NO to YES, the process advances to a step S45 so as to set the high-resolution mode to the image sensor 18.

In a step S47, the process waits until the optimal exposure time period defined by the strict AE process has elapsed, and in a step S49, it is determined whether or not the battery voltage Vtt is equal to or more than the threshold value TH_low. When a determined result is YES, the process advances to a step S51 so as to close the shutter unit 16 through the driver 20c. Upon completion of the closing behavior of the shutter unit 16, the process advances to a step S53. On the other hand, when a determined result of the step S49 is NO, the process directly advances to a step S53.

In the step S53, the image sensor 18 is requested to output one frame of raw image data created after the shutter button 40sh is fully depressed. High-resolution raw image data is outputted from the image sensor 18, and YUV formatted image data based thereon is written into the SDRAM 30 by the memory control circuit 28.

In the step S55, the memory I/F 36 is commanded to execute the recording process. The memory I/F 36 reads out the high-resolution image data stored in the SDRAM 30 through the memory control circuit 28, and records the read-out image data on the recording medium 38 in a file format. Upon completion of the process in the step S55, the process returns to the step S41.

As can be seen from the above-described explanation, the image sensor 18 repeatedly outputs raw image data corresponding to the optical image captured on the imaging surface. The LCD driver 32 displays the live view image that is based on the raw image data outputted from the image sensor 18, on the LCD monitor 34. The main CPU 26 adjusts the imaging condition (the exposure amount and the focus) based on the raw image data outputted from the image sensor 18 when the shutter button 40sh is half depressed (S21, S27). Moreover, under the imaging condition thus adjusted, the main CPU 26 records the YUV formatted image data that is based on the raw image data outputted from the image sensor 18 onto the recording medium 38, in response to the shutter button 40sh being fully depressed (S43, S53 to S55). However, when the battery voltage Vtt falls below the threshold value TH_high, the main CPU 26 stops the image sensor 18 and the LCD driver 32 during a period of non-operation of the shutter button 40sh (S5, S9).

Thus, the live view image representing the scene captured by the image sensor 18 is displayed on the LCD monitor 34, the imaging condition is adjusted when the shutter button 40sh has been half depressed, and the image data representing the scene captured by the image sensor 18 is recorded when the shutter button 40sh has been fully depressed.

Based on this, when the battery voltage Vtt is equal to or more than the threshold value TH_high, the image sensor 18 and the LCD driver 32 are activated irrespective of operation/non-operation of the shutter button 40sh. In contrary, when the battery voltage Vtt is less than the threshold value TH_high, the image sensor 18 and the LCD driver 32 are stopped during the period of non-operation of the shutter button 40sh. Thereby, the power consumption is constrained, and the operability is improved.

It is noted that, in this embodiment, in a case where the buttery voltage Vtt falls below the threshold value TH_high, both of the image sensor 18 and the LCD driver 32 are stopped during the period of non-operation of the shutter button 40sh. However, one of the image sensor 18 and the LCD driver 32 may be a target to be stopped during the period of non-operation of the shutter button 40sh under a condition under which the battery voltage Vtt falls below the threshold value TH_high.

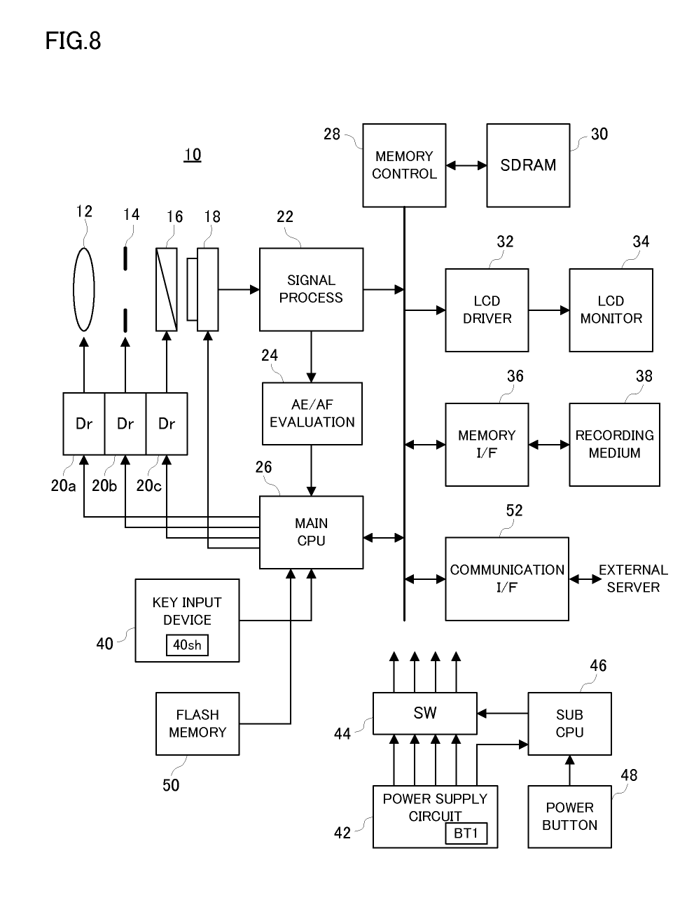

Moreover, in this embodiment, the control programs equivalent to the multi task operating system and a plurality of tasks executed thereby are previously stored in the flash memory 50. However, a communication I/F 52 may be arranged in the digital camera 10 as shown in FIG. 8 so as to initially prepare a part of the control programs in the flash memory 50 as an internal control program whereas acquire another part of the control programs from an external server as an external control program. In this case, the above-described procedures are realized in cooperation with the internal control program and the external control program.

Furthermore, in this embodiment, the processes executed by the main CPU 26 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an electronic image corresponding to an optical image captured on an imaging surface;
a displayer which displays the electronic image outputted from said imager, in parallel with a process of said imager;
an adjuster which adjusts an imaging condition based on the electronic image outputted from said imager when a specific key is transitioned to a first operation state;
a recorder which records the electronic image outputted from the imager under the imaging condition adjusted by said adjuster, in response to transition of said specific key to a second operation state; and
a stopper which stops said imager and/or said displayer during a period of non-operation of said specific key when a battery voltage falls below a first reference value.

2. An electronic camera according to claim 1, further comprising:
a shielder which shields an incident light on said imaging surface;
a driver which drives said shielder in association with a process of said recorder; and
a restrictor which restricts a process of said driver when the battery voltage falls below a second reference value smaller than the first reference value.

3. An electronic camera according to claim 2, wherein said imager adopts a rolling shutter system as an exposure system.

4. An electronic camera according to claim 1, wherein said specific key is equivalent to a shutter button, and the first operation state and the second operation state are respectively equivalent to a half-depressed state and a fully-depressed state.

5. An imaging control program recorded on a non-transitory recording medium in order to control an electronic camera provided with an imager which repeatedly outputs an electronic image corresponding to an optical image captured on an imaging surface; and a displayer which displays the electronic image outputted from said imager, in parallel with a process of said imager, the program causing a processor of the electronic camera to perform the steps comprising:
an adjusting step of adjusting an imaging condition based on the electronic image outputted from said imager when a specific key is transitioned to a first operation state;
a recording step of recording the electronic image outputted from the imager under the imaging condition adjusted by the adjusting step, in response to transition of said specific key to a second operation state; and
a stopping step of stopping said imager and/or said displayer during a period of non-operation of said specific key when a battery voltage falls below a first reference value.

6. An imaging control method executed by an electronic camera provided with an imager which repeatedly outputs an electronic image corresponding to an optical image captured on an imaging surface; and a displayer which displays the electronic image outputted from said imager, in parallel with a process of said imager, comprising:
an adjusting step of adjusting an imaging condition based on the electronic image outputted from said imager when a specific key is transitioned to a first operation state;
a recording step of recording the electronic image outputted from the imager under the imaging condition adjusted by the adjusting step, in response to transition of said specific key to a second operation state; and
a stopping step of stopping said imager and/or said displayer during a period of non-operation of said specific key when a battery voltage falls below a first reference value.
